(19) United States
(12) Patent Application Publication
(10) Pub. No.: US 2002/0048070 A1
(43) Pub. Date: Apr. 25, 2002

(54) System and method for optical fiber telecommunication by simultaneous transmission in two optical windows

(76) Inventor: Ildar R. Gabitov, Los Alamos, NM (US)

Correspondence Address: ANDREA L. MAYS, ESQ., PEACOCK, MYERS & ADAMS, PC, P.O. BOX 26927, ALBUQUERQUE, NM, 87125-6927, US

(21) Appl. No.: 09/767,759

(22) Filed: Jan. 23, 2001

Related U.S. Application Data
(60) Provisional application No. 60/243,258, filed on Oct. 25, 2000.

(51) Int. Cl. H04B 10/00; H04B 10/12

(52) U.S. Cl. 359/173; 359/152

(57) ABSTRACT

The present invention is directed to a system and method in which the transmission capacity of an existing fiber optical system operating at the 1.5 micrometer wavelength range is increased by opening a second optical communication window in a λ-range centered at 1.3 micrometer and enabling the full utilization of that additional bandwidth. More specifically, in a fiber optical information system operating with optical signals in a λ-range centered at 1.55 micrometer, a Raman pump laser is linked to the system to provide counter-propagating light at a wavelength in a λ-range centered at 1.24 micrometer to open a second optical communication window enabling the fill utilization of an additional bandwidth in a λ-range centered at 1.31 micrometer for the simultaneous transmission of optical signals in both the 1.3 and 1.5 micrometer wavelength range.

### RELATED APPLICATIONS

This application is based on provisional application Ser. No.: 60/243,258, filed Oct. 25, 2000, titled: “System and Method for Optical Fiber Telecommunication By Simultaneous Transmission in Two Optical Windows”.

### FIELD OF THE INVENTION

The present invention is directed to a system and method for increasing the capacity of optical fiber telecommunication by the simultaneous transmission in two optical windows.

### BACKGROUND OF THE INVENTION

The use of fiber-optics based telecommunication systems has become widespread and has enabled the transfer of massive quantities of data at extremely fast speed due to the great bandwidth of this optical fiber. The immediate effect has been a revolution in information technology encompassing audio, video and computer data transfer. This readiness has caused a dramatic increase in the demand for services that involve information transfer, which results in an industrial endeavor to deliver more data at an even faster speed to meet popular demand.

The telecommunication industry has focused on the transmission in optical fiber in the 1.5 μm (1 μm=1 micrometer) transparency window (commonly referred to as the 3^{rd} window, having wavelengths in the range of approximately 1.51 to 1.58 μm). Research efforts have been directed mainly to improve the data rates in this 3^{rd} window in various ways such as the use of dense wavelength division multiplexing (DWDM), by increasing the single channel capacity, by extending the gain profile of Erbium doped fiber amplifiers (EDFA's) by means of Raman amplifiers or by using Raman amplifiers in addition to EDFA's.

U.S. Pat. No. 5,959,750 discloses an upgrade method in which Raman amplification is added to an existing transmission system to provide an increase in power budget and permit a substantial increase in transmission capacity either by time division multiplexing (TDM), wavelength division multiplexing (WDM), or a combination thereof. The power budget improvement permits higher transmission capacity by increasing either a single channel data rate and/or the number of wavelength division multiplexed data channels that can be accommodated by existing fiber links.

U.S. Pat. No. 6,043,914 discloses dense wavelength division multiplexing within a 1310 nm band over a single mode fiber. Carrier wavelengths are selected from within two windows, a low subband and/or a high subband, on either side of a guardband. The guardband includes the zero dispersion wavelength.lambda..sub.0 of a single-mode fiber in the optical communication link and separates low subband and high subband within the 1310 nm band. Dispersion compensation is provided for carrier signals in each dense WDM channel in the low and high subbands.

### SUMMARY OF THE INVENTION

The present invention is directed to a system and method in which the transmission capacity of an existing optical fiber system operating in the 1.5 μm wavelength range is increased by opening a second optical communication window in a wavelength (λ-) range centered at 1.31 μm and enabling the full utilization of that additional bandwidth. More specifically, in a fiber optical information system operating with optical signals in a λ-range centered at 1.55 μm, a Raman pump laser is linked to the system to provide counter-propagating or combination of counter-propagating and co-propagating light at a wavelength in a λ-range centered at 1.24 μm to open a second optical communication window enabling the full utilization of additional bandwidth in a λ-range centered at 1.31 μm for the simultaneous transmission of optical signals in both the 1.3 and 1.5 μm wavelength range.

### BRIEF SUMMARY OF THE DRAWINGS

FIG. 1 is a diagram plotting light energy loss and dispersion properties versus wavelength of a conventional single-mode silica optical (STF—standard telecommunication fiber) fiber;

FIG. 2 is a schematic diagram illustrating the present invention;

FIG. 3 is a graph plotting energy gain vs. wavelength in an optical fiber when excited by light at a 1.24 μm wavelength is sent through an existing optical fiber link thus inducing gain in a λ-range centered at 1.31 μm;

FIG. 4 illustrates the data stream of a single channel at an operating λ- of 1.31 μm both at the input (top) and output (bottom) of a link of optical fiber;

FIG. 5 shows two graphs for the input and output of a fiber link operating with multiple channels, illustrating the possibilty of using wave-length-division multiplexing techniques in the second optical window; and

FIG. 6 is a schematic diagram of the system of the present invention operating in the third optical communication window in a λ-range centered at 1.55 μm and in the second optical communication window in a λ-range centered at 1.31 μm.

### DESCRIPTION OF THE PREFERRED EMBODIMENTS

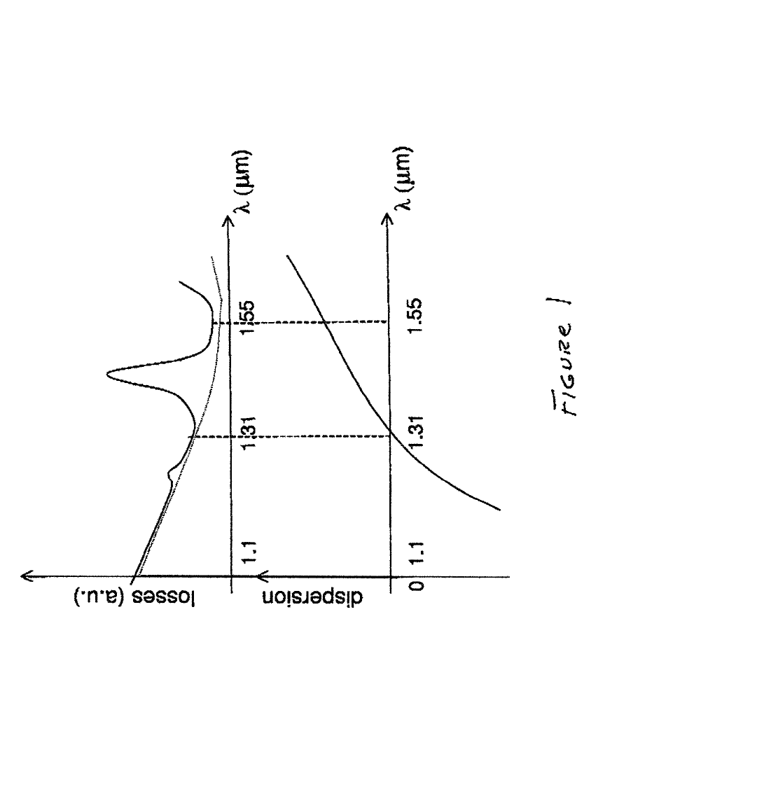

Telecommunication applications in optical fibers are intimately dependent on the physical properties of the fiber itself. The common silica fibers that are being used presently have certain characteristics that have to be contended with on a fundamental basis in the design of optical telecommunication systems. Two basic features of optical fibers are the light energy loss and the chromatic dispersion of the light pulses over the length of the fiber. These fundamental material properties affect any data signal transmitted over the length of the fiber such that the signal sent at one end of the fiber and the signal received at the other end of the fiber is not identical. Among other things, these characteristics define the wavelength limits over which data can be transmitted through a length of optical fiber. These basic characteristics can be understood with the help of FIG. 1. The upper portion of the graph plots the energy losses in a silica optic fiber (there being more than one mechanism causing loss) as a function of light wavelength. This plot indicates the existence of three windows of optical transparency at approximately 1.1 μm (1^{st} window), approximately 1.3 μm (2^{nd} window), and approximately 1.5 μm (3^{rd} window). All the aforementioned windows correspond to regions of minimum energy loss for silica fibers, with the lowest loaa ocurring in the third window (approximately 1.55 μm). It must be noted that this represents an intrinsic physical property of the fiber material constituents and applies to all conventional silica optical fibers.

Now referring to the lower portion of the plot in FIG. 1, chromatic dispersion in a standard silica optic fiber is plotted versus wavelength. The lowest dispersion value (zero dispersion point) is found at approximately 1.3 μm (i.e. within the 2^{nd} window). Fiber chromatic dispersion is one of the key factors which limits the information carrying capacity of optical fibers. The availability of optical regenerators operating at 1.3 μm and the absence of optical amplifiers at 1.5 μm determined the initial design of optical fiber systems to be in the second telecommunication window, placing optical telecommunications in the zero-dispersion region of wavelength or more specifically the second optical communication window of operation as illustrated in FIG. 1. Transmission of digitized data requires preservation of the digitally encoded signal (bit pattern), which in turn means that light pulses must propagate relatively undistorted, i.e. experience low dispersive broadening. The fundamental objective is to receive a pulse of light as close to the pulse transmitted so that it faithfully reproduces the bit pattern that was originally sent. However, the widespread availability of Erbium-doped fiber amplifiers (EDFA) and other improvements that correct the pulse received to make it identical to the pulse transmitted in combination with the lower losses in the third optical communication window has favored the operation of conventional operation of fiber optical systems to the third optical communication window. Nowadays, these systems are ubiquitous and as a consequence, the main industrial effort is spent to improve and enhance the capacity of communication systems in this 1.5 μm wavelength region either by using dense-wavelength division multiplexing (DWDM), by extending the gain profile of Erbium doped fiber amplifiers (EDFA's) by means of Raman amplifiers or using Raman amplifiers in addition to EDFA's and combinations of these approaches. All solutions, however, are aimed at the control of parameters and properties of systems operating in the third communication window in order to fully exploit the physical bandwidth available in the optical fiber.

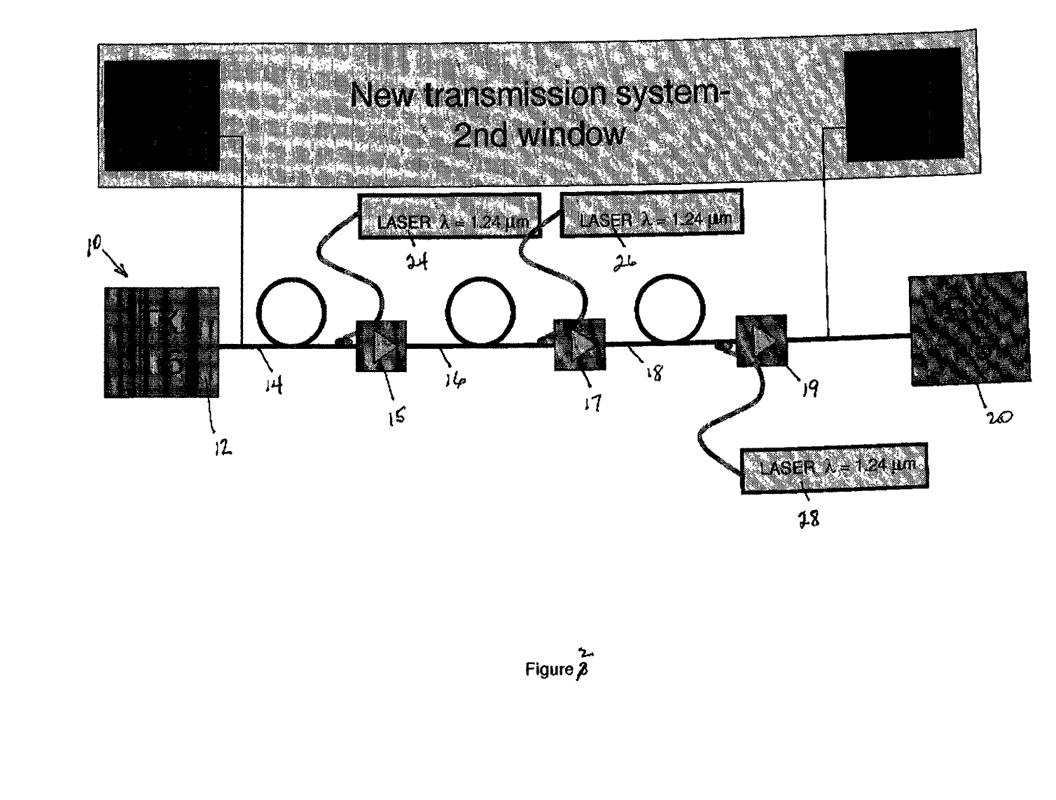

With the foregoing fundamentals set forth, the present invention and the specific embodiment is described. Referring now to FIG. 2, a conventional silica optic fiber system 10 includes a transmitter 12 operating in the 3^{rd} optical communication window (meaning the transmitter operates at the 1.55 μm wavelength region), a plurality of silica-based optical fiber links 14, 16 and 18 and each link having an optical amplifier 15, 17 and 19, and an optical receiver 20. In the conventional system employed, it is necessary to have the amplifiers 15, 17 and 19 at the end of each link or before the receiver to boost the signal energy to a level detectable by the receiver, thus faithfully reproducing the digitized pattern sent at the input of the fiber. According to the present invention, a plurality of Raman lasers 24, 26, and 28, one in each link, is added to the conventional system 10. The lasers provide a counter-propagating light at a wavelength in a λ-range centered at 1.24 μm to stimulate or increase the energy gain in the optical fiber at wavelengths in a λ-range centered at 1.31 μm. Preferably, the Raman laser uses light with a wavelength of 1.24 μm to stimulate or activate the optical fiber to maximize the energy gain in the optical fiber over the 1.31 μm wavelength region, with the added advantages of distributed amplification.

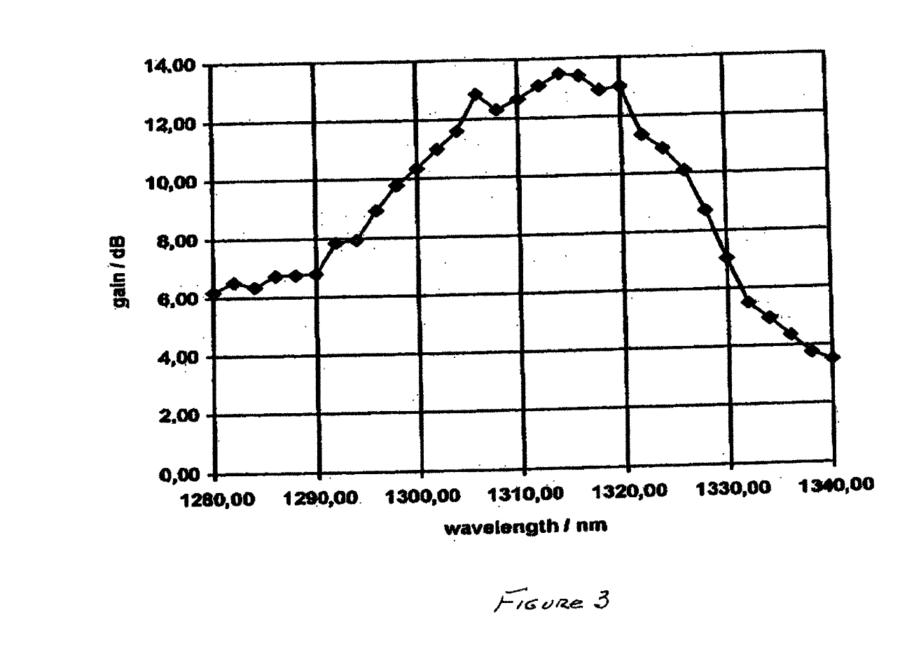

The significance of the present invention is better understood with reference to FIG. 3. Referring to FIG. 3, this graph discloses the gain variations (inverse to loss) in a standard telecommunication fiber (STF) when a compact high efficient diode-pumped Raman laser delivers a light at a wavelength of 1.24 μm. The Raman laser is a Yb-doped fiber laser in conjunction with cascaded Raman wavelength conversion in a special resonator design having up to 600 mW power. The Raman laser induces gain in the fiber from 1305 nm to 1320 nm. The gain profile is flat over that range, which represents an important feature of the present invention to open or utilize the bandwidth of the optical fiber in the 2^{nd} optical communication window. It is clear that by optimizing the parameters of operation of the Raman laser, the gain can be extended to occupy more of the bandwidth of the second optical communication window. The most significant point is that the Raman induced gain allows the opening and a more efficient use of a second window for data communicationm. The great wavelength separation of this band from the normal optical system bandwidth centered at 1.55 μm allows simultaneous transmission over both optical communication windows.

The power of the Raman laser used does not change the range of wavelength having a minimum loss of the optic fiber in the 2^{nd} optical communication window but increased power does increase the amount of gain. Stated in a different way, the shape of the curve of energy gain in FIG. 2 will remain the same; however, the greater the power of the Raman laser the higher the curve (higher gain on y-axis—higher curve). Distributed Raman gain was induced in a randomly chosen sample of standard monomode fiber 37.8 km long. The total value of the loss in the system was ˜13 dB. It was observed that a Raman laser with 330 mW of pump power creates 8 dB gain and in another case, for a different segment of fiber, with 500 mW of pump power creates 12 dB gain in 35 km of standard mono-mode fiber, i.e., creates optical transparency.

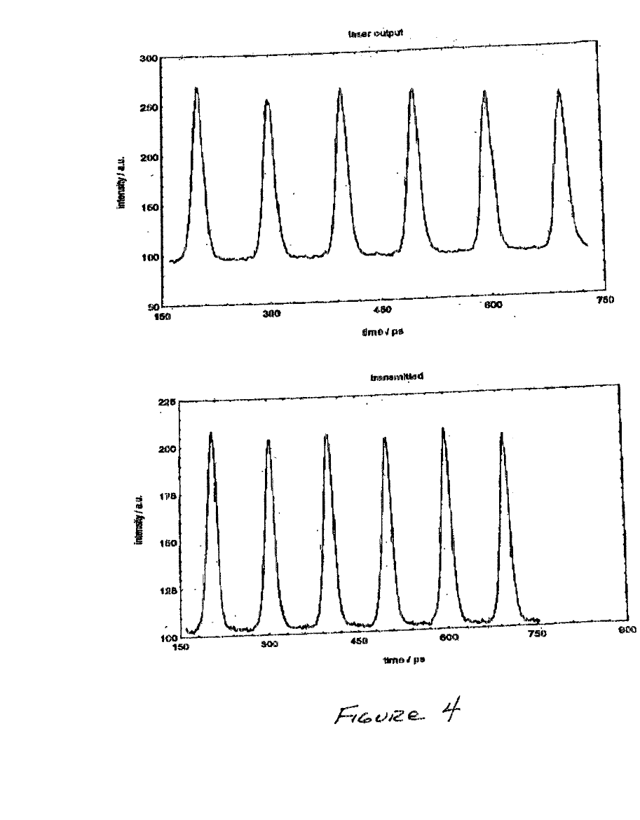

Referring to FIG. 4, the two graphs illustrate the distortion free transmission in a standard mono-mode fiber in the 1.31 μm wavelength optical window using distributed Raman amplification. The upper plot represents a periodic data stream consisting of pulses (having a duration of 18 ps=18×10⁻¹² seconds) at a 10 Ghz repetition rate. The lower plot represents the output signal after propagating through 37.8 km of a standard monomode fiber with distributed Raman amplification, obtained by a counter-propagating Raman pump laser operating at 1240 nm. The value of the total energy loss in the segment of optical fiber is found to be ˜13 dB, the value of the gain is ˜12 dB. The received signal at the fiber output reproduces the signal sent at the fiber input.

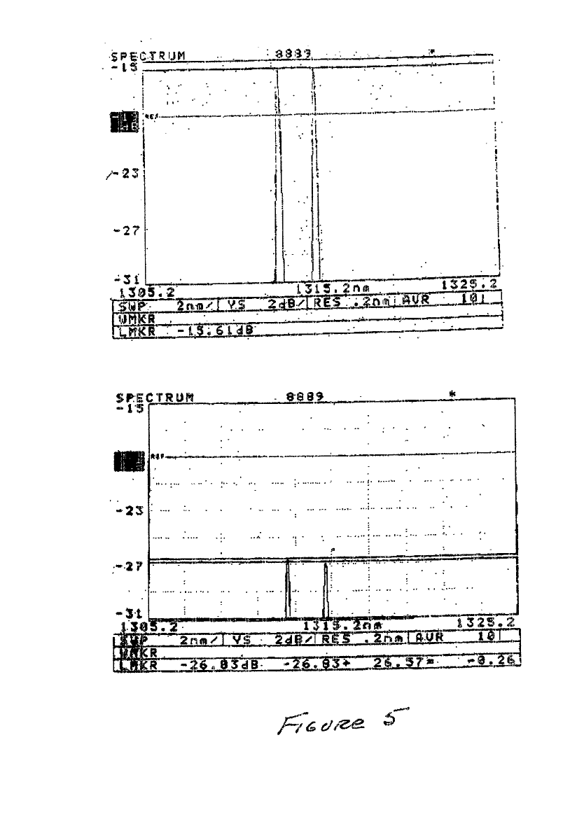

Referring to FIG. 5, these two graphs illustrate the wavelength division multiplexing (WDM) application in a system which uses distributed Raman amplification through a counter-propagating Raman pump laser operating at 1240 nm. Two co-propagating continous wave (CW) signals separated by ˜2 nm were launched into 37.8 km of standard monomode fiber with distributed Raman amplification. The lower plot shows the signal which is sent into the fiber link. The upper plot represents the output signal after propagation through 37.8 km of standard monomode fiber with distributed Raman amplification. It is noted that the gain is independent of whether a single channel or multiple channels are sent through the fiber.

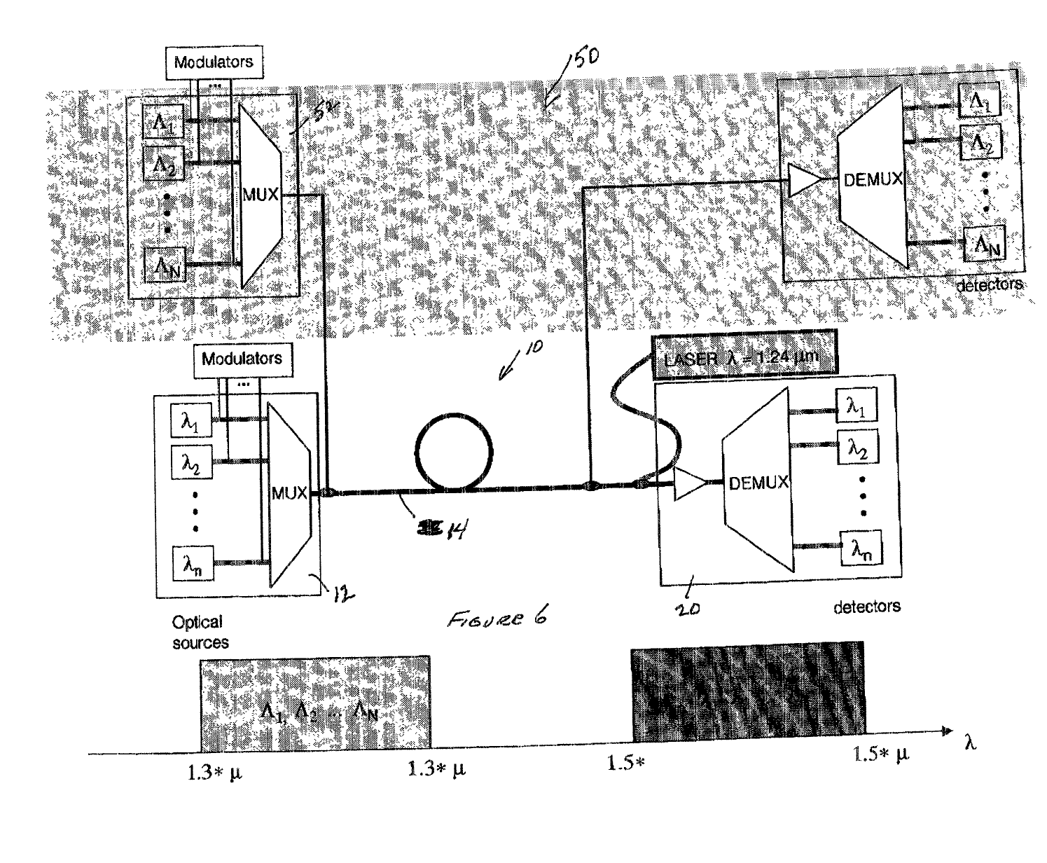

Referring to FIG. 6, a system of the present invention 50 is completely set forth. The system is illustrated in conduction with a conventional system 10 with a single optical fiber link 14 but it is clearly understood that the system may contain many links 14, 16, 18 etc. (or expressed as link 14 sub 1, link 14 sub 2 . . . link 14 sub n) and an optical amplifier in each link (not shown). A multiplexer 12 is illustrated as the transmitter which transmits signals in the λ-range centered at 1.55 μm and a demultiplexer 20 as the reciever. According to the present invention a Raman laser is linked into each link 14 sub 1−n with counter-propagating light in a λ-range centered at 1.24 μm to stimulate the optic fiber in the 1.3 μm wavelength range. This permits the suberposition of a transmission system consisting of a second multiplexer 52 which transmitts signals in the λ-range centered at 1.31 μm to be added to the system of the present invention as well as a second demultiplexer 60 to receive the signals in the 1.3 μm wavelength range. The Raman laser used in each link 14 has sufficient power to provide a system power gain sufficiently close to the power loss in the system to maintain transparency in the optic fiber in the λ-range centered at 1.31 micrometer.

The limitation caused by dispersion broadening is defined by the dispersion length Z sub d which is proportional to tauˆ 2/D. The distance Z sub d represents the length at which the chromatic dispersion D broadens the pulse tau by a factor of two. The dispersion value in the 1.5 μm optical window is approximately 15-17 ps/nm.Km. The dispersion curve of STF crosses the zero value point within the 1.3 μm window. This implies that the dispersion value can be very small in this window depending on the selection of the carrier frequency. In particular, if D=1 ps/nm.Km, the same value of dispersion length corresponds to optical pulses four times shorter than the ones employed in the 1.5 mm optical window. In this case channel capacity is 4 times larger than in the 1.5 mm optical window. Operation in the second window, therefore, enables an increase in frequency channel capacity of (at least) a factor of four (4) due to the physical properties of the STF. This capability will permit the optical fiber to be linked with other high speed transmission system which cannot be done at the present time due to the limited speed in the 1.5 micrometer wavelength range.

There are modifications that are within the spirit of the present invention that have not been stated but are within the scope of the claims herein. For example, there are presently known optical fiber systems using fibers other than STF, and the same approach will apply but the wavelengths may change according to the physical properties of the fiber used.

1. The improvement to an optical communication system having an optical fiber communication link between two nodes, the optical fiber link having a first end and a second end; a first optical transmitter coupled to the optical fiber link adjacent the first end, the first optical transmitter configured to transmit signals in the 1.5 μm wavelength range (the third optical communication window); a first optical receiver coupled to the optical fiber link adjacent the second end, the first optical receiver configured to receive optical signals in the third optical communication window, comprising:
a Raman pump laser coupled to the optical link adjacent the second end, the Raman pump laser providing counter-propagating light at a wavelength in a λ-range centered at 1.24 μm to open an optical communication window in the 1.3 μm wavelength range to provide a second window for the simultaneous transmission of optical data;
a second optical transmitter coupled to the optical fiber link adjacent to the second end, the second optical receiver configured to transmit optical signals in the 1.3 μm wavelength range to provide a second window for the simultaneous transmission of optical data; and
a second optical receiver coupled to the optical fiber link adjacent to the second end, the second optical receiver configured to receive optical signals in the 1.3 μm wavelength range whereby simultaneous optical communication is carried out in both the 1.5 and 1.3 μm wavelength range.

2. A system according to claim 1 wherein said Raman laser provides counter-propagating light at a wavelength of 1.24 μm.

3. A system according to claim 1 wherein said Raman laser provides a combination of counter-propagating and co-propagating light at a wavelength of 1.24 μm.

4. A method for increasing the transmission capacity by enabling the full utilization of an additional bandwidth of an existing optical fiber information system, the existing optical fiber information system including a first optical transmitter coupled to a optical fiber link adjacent a first end and an optical receiver coupled to a optical fiber link adjacent a second end, the first optical transmitter configured to transmit an optical data signal in the λ-range centered at 1.5 μm, the method comprising:
stimulating the existing optical fiber by a counter-propagating light at a wave length in a λ-range centered at 1.24 μm to open a second optical communication window without affecting the optical data signal in the 1.5 μm wavelength range whereby a second transmitter and receiver are added to the system for the simultaneous transmission of optical data signals in two optical communication windows.

5. A method according to claim 1 whereby said stimulation is provided by a Raman pump laser coupled to an optical fiber link adjacent the second end of said optical fiber.

6. A method for increasing the transmission capacity of an existing optical fiber information system, said existing optical fiber information system including a first optical fiber link adjacent a first end of said fiber and a second optical fiber link adjacent a second end of said fiber, said system configured to transmit an optical data signal in the 1.5 μn wavelength range, the method comprising:
stimulating the existing optical fiber by a propagating light at a wave length in a λ-range centered at 1.24 μm to open a second optical communication window without affecting the optical data signal in the 1.5 micrometer wavelength range.

7. A method according to claim 6 whereby said stimulation is provided by a Raman pump laser coupled to an optical fiber link adjacent the second end of said optical fiber and provides a counter-propagating light.

8. An optical fiber information system, said optical fiber information system including a first optical fiber link adjacent a first end of said optical fiber and a second optical fiber link adjacent a second end of said optical fiber, comprising:
a Raman pump laser connected through said optical fiber link adjacent to said second end of said optical fiber providing a counter-propagating light at a wave length in a λ-range centered at 1.24 μm to expand the useable bandwidth in the optical communication window in a λ-range centered at 1.31 μm without affecting the optical data signal in the 1.5 micrometer wavelength range.

9. An optical fiber information system, said optical fiber information system including a first optical fiber link adjacent a first end of said optical fiber and a second optical fiber link adjacent a second end of said optical fiber, comprising:
a Raman pump laser connected through said optical fiber link adjacent to said second end of said optical fiber providing a counter-propagating light at a wave length in a λ-range centered at 1.24 μm, said Raman pump laser having a power sufficient to provide a gain in said optical fiber system that is substanially equal to the power loss in said system whereby said optical fiber is transparent in a λ-range centered at 1.31 μm.

10. A system according to claim 9 including transmission means connected to said first optical fiber link adjacent said first end of said optical fiber and receiving means connected to said second optical fiber link adjacent said second end of said optical fiber for the simultaneous transmission of optical data signals in both the λ-range centered at 1.31 μm and the λ-range centered at 1.55 μm whereby the bit rate of the signal in the 1.3 μm range is at least 4 times faster than the signal in the 1.5 μm range.
